(19) United States
(12) Patent Application Publication
(10) Pub. No.: US 2006/0170323 A1
(43) Pub. Date: Aug. 3, 2006

(54) Fluorescent lamp

(76) Inventors: Michael E. Hirsch, Cherry Hill, NJ (US); Douglas R. Bray, Medford Lakes, NJ (US); Dwight D. Santiago, Moorestown, NJ (US); Andrzej B. Duljas, Moorestown, NJ (US)

Correspondence Address: Gregory J. Lavorgna, Esquire;Drinker Biddle & Reath LLP, One Logan Square, 18th & Cherry Streets, Philadephia, PA, 19103-6996, US

(21) Appl. No.: 11/328,989

(22) Filed: Jan. 10, 2006

Related U.S. Application Data
(60) Provisional application No. 60/642,958, filed on Jan. 11, 2005.

(51) Int. Cl. H01J 5/48

(52) U.S. Cl. 313/318.01

(57) ABSTRACT

A fluorescent lamp includes a ballast releasably connected to an adapter in a bayonet style connection. The adapter includes a locking tab for preventing removal of the adapter from an electrical socket once the adapter has been installed in the electrical socket. The fluorescent lamp has a lamp tube. The lamp tube is preferably connected to a base in a manner to minimize the total height of the fluorescent lamp. The lamp base is preferably provided with a recess in which contact pins are connected to the lamp base. The lamp may be directly connected to the ballast. The lamp tube may be arranged in a coil having a greater radial outer extent than the base or than the ballast.

### CLAIM OF PRIORITY AND CROSS REFERENCE

This application claims the benefit of and herein incorporates by reference, in its entirety, U.S. Provisional Patent Application: 60/642,958, filed Jan. 11, 2005, entitled, “FLUORESCENT LAMP”.

### FIELD OF THE INVENTION

The invention pertains to fluorescent lamps generally and in particular to fluorescent lamps adapted to be used with light fixtures designed for incandescent bulbs.

### BACKGROUND OF THE INVENTION

Incandescent lamps have been in use for over a hundred years, and remain in widespread use. They are relatively inexpensive to purchase and easy to replace. Fluorescent lamps use less energy than incandescent lamps. They are, however, initially more expensive to purchase than incandescent bulbs and more expensive to replace, and may not be as readily available as incandescent bulbs, which can be found at many retail locations.

Although fluorescent lamps are more energy-efficient, many light fixtures are designed only for standard incandescent light bulbs. To use a fluorescent lamp in such fixtures requires an adapter. Adapters for allowing fluorescent lamps to be used in place of incandescent lamps in such fixtures are known. Typically, such adapters include a housing that contains or can receive a fluorescent ballast, a socket for receiving the contact pins of a fluorescent lamp, and a threaded ring contact and a tip contact similar or identical to those on the base of a standard incandescent bulb, which allows the adapter to be simply screwed into a standard incandescent socket.

Typically, known fluorescent adapters can be removed from a standard incandescent socket just as easily as they can be installed. That is not normally a problem, but in some cases it is desirable to prevent the adapter from being removed after installation. For example, some manufacturers of fluorescent lamps are partners in ENERGY STAR®, a program sponsored by the U.S. Environmental Protection Agency to promote energy efficiency. Many manufacturers of electrical appliances are ENERGY STAR® partners, and many of the ENERGY STAR® partners offer rebates on qualified products. In those cases, it would defeat the purpose of the ENERGY STAR® program, and subject manufacturers to payment of unnecessary rebates, if the fluorescent adapter could be removed and the consumer could revert to incandescent bulbs.

Furthermore, conventional fluorescent lamps comprise tubing which has ends mounted to a base having a top such that the ends extend generally perpendicularly to the top, parallel to a longitudinal axis of the lamp assembly. Intermediate the ends, the tubing forms a coil having an outer radius generally equal to a radius of the base. This arrangement of the tubing, while functional, does not provide the most longitudinally compact design. In order to fit as many conventional incandescent lamp fixtures as possible, it would be desirable to have a lamp with a more compact overall height.

Still further, conventional fluorescent lamps for use with an incandescent adapter have a ballast portion which connects to the adapter via generally straight pins which fit within generally straight receptacles. This is arrangement is satisfactory when the lamp is oriented with the tubing above the ballast and adapter. However, if the lamp is oriented with the tubing positioned below the ballast and adapter (in an “inverted” position), the straight pin connection between the ballast and the adapter is unable to support a substantial weight load. It would be desirable to provide a connection between the ballast and the adapter which would support additional load in this inverted orientation.

There is a need for a fluorescent lamp having an adapter that (1) can be installed as easily as an incandescent light bulb but that cannot be removed after installation, that (2) provides a lamp assembly having a ballast portion with the capability of supporting greater weight loads when the lamp is in an inverted position, and that (3) has a longitudinally compact design. The present invention meets those needs.

### BRIEF DESCRIPTION OF THE DRAWINGS

For illustrating the invention, there is shown in the drawings forms of the invention that are presently preferred; it being understood, however, that this invention is not limited to the precise arrangements and instrumentalities shown.

FIG. 1 is a side view of a fluorescent lamp assembly in accordance with a first preferred embodiment of the present invention.

FIG. 2 is an exploded side view of the assembly of FIG. 1.

FIG. 3 is an enlarged side view of an adapter element of the lamp assembly of FIG. 1.

FIG. 4 is an enlarged top plan view of the adapter of FIG. 3.

FIG. 5 is an exploded side view of a fluorescent lamp assembly in accordance with a second preferred embodiment of the present invention.

FIG. 6 is a side view of the assembly of FIG. 5, shown in an assembled condition.

FIG. 7 is an exploded side view of a fluorescent lamp assembly in accordance with a third preferred embodiment of the present invention.

FIG. 8 is a side view of the assembly of FIG. 7, shown in an assembled condition.

FIG. 9 is an exploded side view of a fluorescent lamp assembly in accordance with a fourth preferred embodiment of the present invention.

FIG. 10 is a side view of the assembly of FIG. 9, shown in an assembled condition.

FIG. 11 is an exploded side view of the fluorescent lamp of FIG. 9, shown with a lamp enclosure.

FIG. 12 is a side view of a fluorescent lamp assembly in accordance with a fifth preferred embodiment of the present invention, shown with a non-threaded ballast housing.

FIG. 13 is a side view of the lamp assembly of FIG. 12, shown with a threaded ballast housing.

FIG. 14 is a side view of a fluorescent lamp assembly in accordance with a sixth preferred embodiment of the present invention.

FIG. 15 is a top plan view of the fluorescent lamp assembly of FIG. 14.

FIG. 16 is side view of a fluorescent lamp in accordance with a seventh preferred embodiment of the present invention.

FIG. 17 is a side view of an adapter in accordance with an eighth preferred embodiment of the present invention for use with a fluorescent lamp.

FIG. 18 is a top plan view of the adapter of FIG. 17.

FIG. 19 is a side view of an adapter in accordance with a ninth preferred embodiment of the present invention for use with a fluorescent lamp.

FIG. 20 is a side view of the adapter of FIG. 21 in combination with a fluorescent lamp and lamp fixture.

FIG. 21 is a side view of an adapter in accordance with a tenth preferred embodiment of the present invention in combination with a fluorescent lamp and lamp fixture.

### DESCRIPTION OF THE PRESENTLY PREFERRED EMBODIMENTS

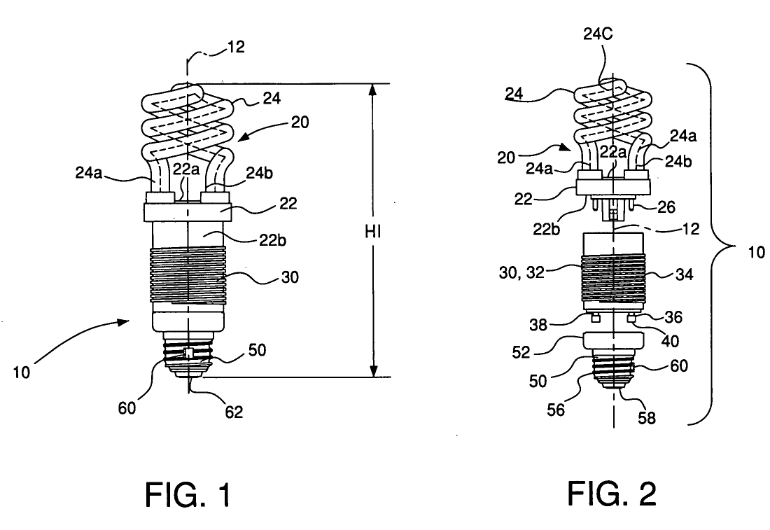

Referring to the drawings, in which like numerals indicate like elements, there is shown in FIGS. 1 and 2 a fluorescent lamp assembly 10 in accordance with a first preferred embodiment of the present invention comprising a fluorescent lamp 20, a ballast 30, and an adapter 50. Fluorescent lamp 20 may be a fluorescent lamp in any of numerous configurations, including conventional helical, spiral, and U-shaped fluorescent lamps. An optional enclosure (not illustrated), for enclosing at least the fluorescent lamp 20, could be provided if desired. The enclosure, if present, may be clear or frosted, as desired. The lamp assembly 10 has an overall height H1, and has a central longitudinal axis 12.

The lamp 20 includes a base 22. In the embodiment illustrated, the base 22 is disc-shaped, having a top 22a and a bottom 22b. A lamp tube 24 is connected to the base 22 at first and second ends 24a and 24b. The lamp tube 24 has a longitudinal axis 24c extending the length of the lamp tube. In the embodiment illustrated, the lamp tube 24 is connected to the base 22 such that the longitudinal axis 24c at each of the first and second ends 24a and 24b extends generally parallel to the lamp assembly longitudinal axis 12. Furthermore, in the embodiment illustrated, the lamp tube 24 is arranged in a coil having an outer radial extent which is substantially equal to a radius of the base 22. The lamp 20 further includes two contact pins 26, extending from the bottom 22b.

As best seen in FIG. 2, fluorescent lamp 20 may be connected in conventional fashion to the ballast 30, which includes two receptacles (not shown) for receiving the contact pins 26. Additional contact pins 26 and mating receptacles (not shown) could be provided. The ballast 30, ballast receptacles (not shown), and lamp contact pins 26 may be conventional. Ballast 30 includes a housing 32, which may be provided with a thread 34. The ballast 30 also includes a pair of input contact pins 36. The input contact pins 36 have a shaft portion 38 and a head 40. Operation of the input contact pins 36 to electrically and mechanically connect the ballast 30 to the adapter 50 is described below. The contact pins 36 cooperate with keyslot receptacles 54 in the adapter 50 to provide a portion of an electrical path from an electrical socket (not illustrated), through the adapter 50 to the lamp 20. The number of input contact pins 36 and adapter receptacles (not shown) may be varied without departing from the scope of the invention.

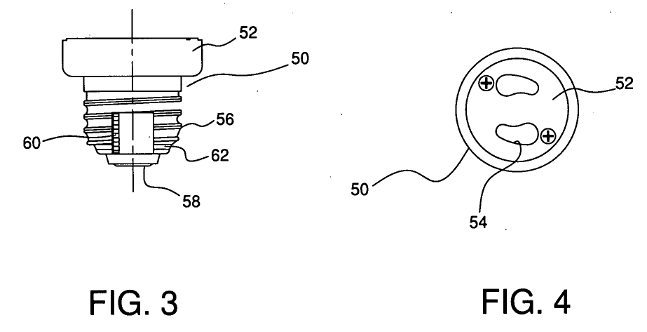

Adapter 50 is shown in enlarged detail views in FIGS. 3 and 4. Adapter 50 includes a threaded conductive ring contact 56 forming a portion of an exterior surface of the adapter 50. The adapter 50 further includes a top portion 52. The keyslot receptacles 54 are provided in the top portion 52, and are adapted to receive the ballast contact pins 36 in a “bayonet” style connection. That is, the contact pins 36 are received within the keyslot receptacles 54 such that a slight twist releasably locks the ballast 30 in place with adapter 50, and so that a slight twist in the opposite direction allows ballast 30 to be separated from the adapter 50. When the ballast 30 is locked to the adapter 50, the head portions 40 engage the keyslot receptacles 54 to prevent the ballast 30 from being separated (along a longitudinal direction) from the adapter 50.

It will be appreciated that one advantage of this locking “bayonet” style connection between the ballast contact pins 36 and receptacles 54 is that it allows greater weight to be supported by the ballast 30 with the lamp assembly 10 in an inverted position (that is, with the lamp 20 and ballast 30 positioned below the adapter 50). For example, if a lamp shade (not illustrated) or other component were connected to the ballast 30 (for example, using the ballast thread 34), the bayonet style connection would allow the ballast 30 to support the weight of the lamp shade while in an inverted position, while remaining firmly connected to the adapter 50. In contrast, a conventional straight contact pin received in a conventional straight receptacle would be less capable of supporting substantial weight in an inverted position.

Ring contact 56 is threaded in the same manner as a conventional incandescent bulb. Similarly, at the bottom end of the adapter 50 is a tip contact 58, also as found on a conventional incandescent bulb. Wires (not shown) provide an electrical path from ring contact 56 and tip contact 58, receptively, to receptacles 54 in top portion 52.

The adapter 50 further includes a locking tab 60, which extends through an opening 62 in the ring contact 56. The locking tab 60 is biased toward a first position by a spring (not shown). In this first position, the adapter 50 may be freely rotated in a first direction to allow the adapter 50 and lamp assembly 10 to be installed by threaded engagement of the ring contact 56 with a conventional incandescent lamp socket in the same manner as a conventional incandescent bulb. When fully installed, tip contact 58 is brought into electrical contact with the lamp socket (not shown).

However, when the lamp assembly 10, including the adapter 50 is rotated in a second direction relative to the lamp socket, the locking tab 60 engages a portion of the lamp socket, compressing the spring (not shown) and tending to rotate the locking tab 60 out of the first position into a second position. In this second position, the locking tab 60 moves into locking engagement with the lamp socket, and prevents further rotation of the adapter 50 relative to the lamp socket (not shown). Thus, the adapter 50 is capable of being freely installed in a lamp socket, but once installed cannot be readily removed from the lamp socket.

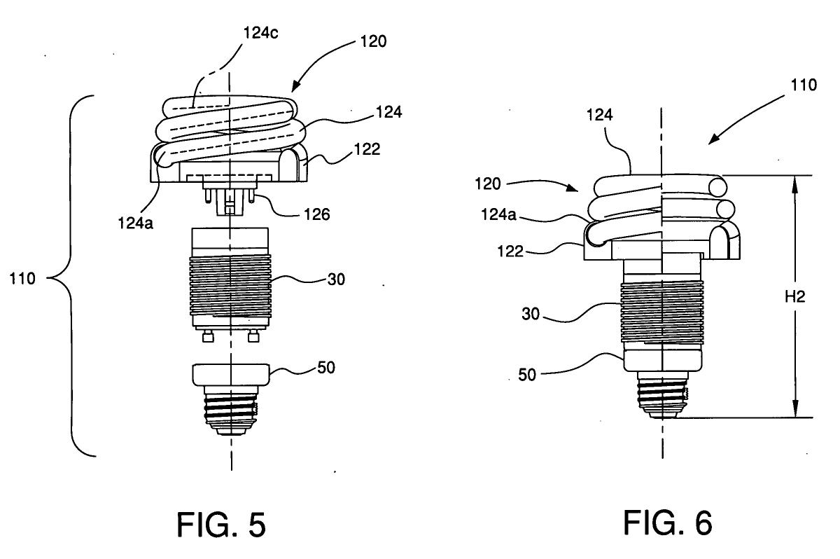

With reference now to FIGS. 5 and 6, a fluorescent lamp assembly 110 in accordance with a second preferred embodiment of the invention comprises a second embodiment fluorescent lamp 120, along with the ballast 30 and adapter 50 common to both the first and second embodiment lamp assemblies 10 and 110. The second embodiment lamp assembly 110 has a longitudinal axis 112. The second embodiment lamp 120 differs from the first embodiment lamp 20 primarily in the arrangement of second embodiment lamp tube 124 relative to second embodiment base 122. Specifically, lamp tube first and second ends 124a and 124b are connected to the base 122 such that longitudinal axis 124c at each of the first and second ends lies in a plane substantially perpendicular to the lamp assembly longitudinal axis 112. Furthermore, the lamp base 122 has a larger diameter than the lamp base 22 of the first embodiment. Likewise, the lamp tube 124 is arranged in a coil having a greater radial extent than the corresponding coil of the first embodiment. This arrangement permits an equivalent length of lamp tubing 124 to be provided as in the first embodiment lamp assembly 10, but the overall height H2 of the second embodiment lamp assembly 110 is less than the overall height HI of the first embodiment lamp assembly 10.

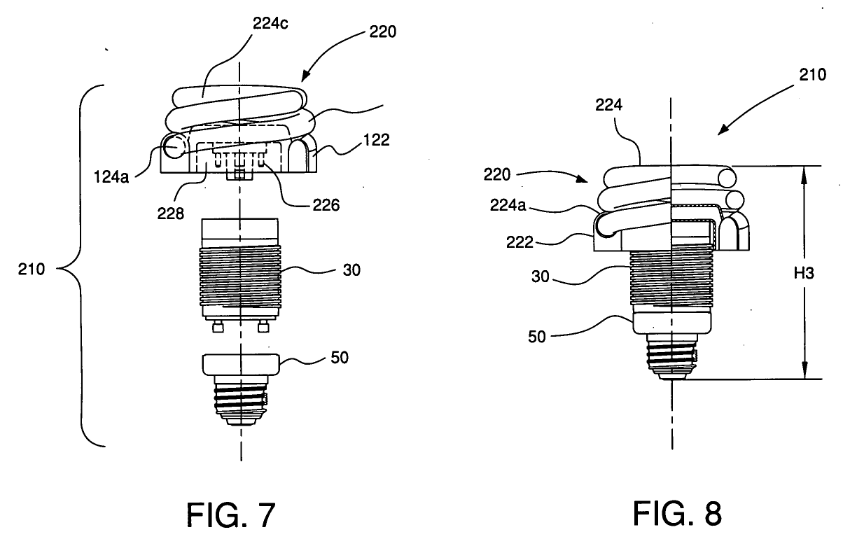

With reference now to FIGS. 7 and 8, a fluorescent lamp assembly 210 in accordance with a third preferred embodiment of the invention comprises a third embodiment fluorescent lamp 220, along with the ballast 30 and adapter 50 common to both the first and third embodiment lamp assemblies 10 and 210. The third embodiment lamp 220 differs from the second embodiment lamp 120 primarily in the construction of the third embodiment lamp base 222. Specifically, the third embodiment lamp base 222 is provided with a recess 228, extending into the base 222 from the base bottom toward the base top. The recess 228 is sized and shaped to receive an end of the ballast 30. The lamp contact pins 226 are connected to the base within the recess 228. The recess 228 further reduces the third embodiment overall height H3 compared to the second embodiment overall height H2.

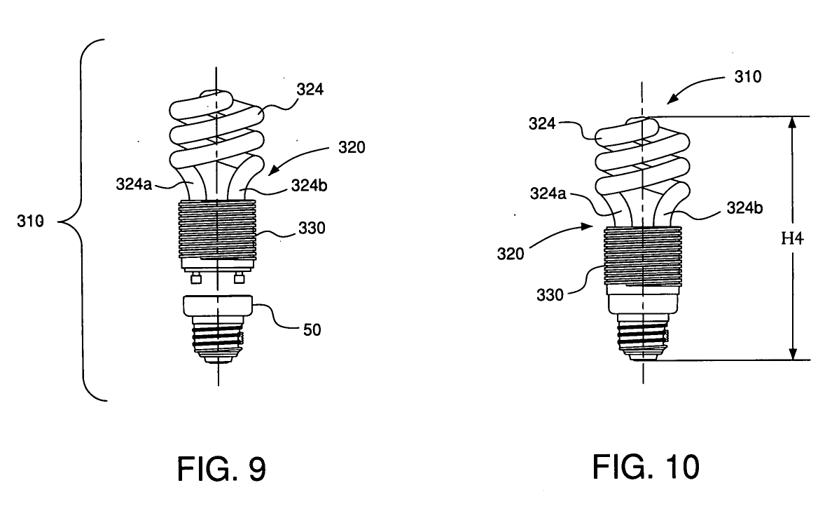

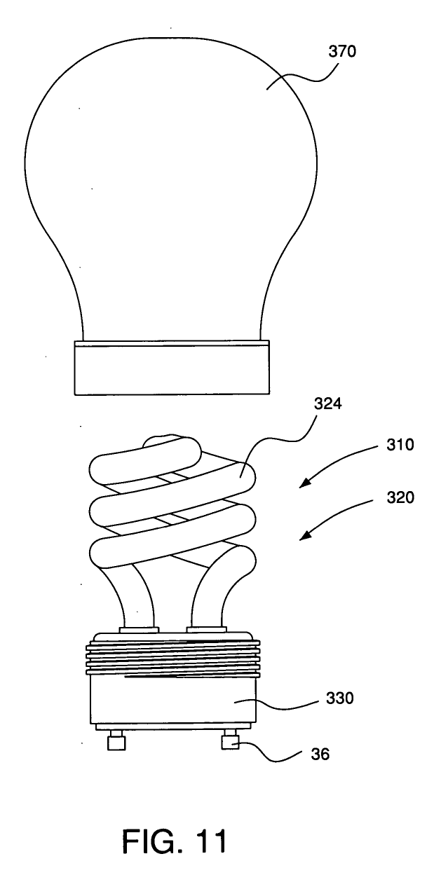

With reference now to FIGS. 9-11, a fluorescent lamp assembly 310 in accordance with a fourth preferred embodiment of the invention differs from the first embodiment lamp assembly 10 in that a fourth embodiment fluorescent lamp 320 is fixedly connected to a second embodiment ballast 330. The need for a separate lamp base, separable from the ballast, is thus eliminated in this fourth embodiment. The fourth embodiment lamp assembly 310 has an overall height H4 which is less than the first embodiment overall height H1. The fourth embodiment lamp assembly 310 may be combined with a lamp enclosure 370, which removably connects with the second embodiment ballast 330 by threaded engagement.

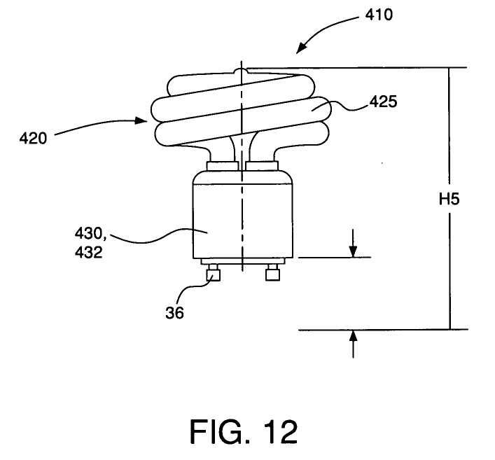

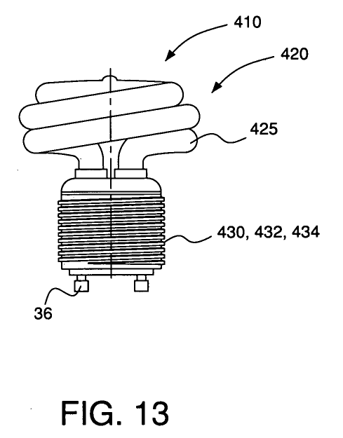

With reference now to FIGS. 12 and 13, a fluorescent lamp assembly 410 in accordance with a fifth preferred embodiment of the invention differs from the fourth embodiment lamp assembly 310 in that a fifth embodiment fluorescent lamp 420 has a greater radial extent than the third embodiment ballast 430 to which the lamp 420 is connected. Similar to the fourth embodiment lamp assembly 310, the fifth embodiment lamp assembly 420 is fixedly connected to the third embodiment ballast 430. Therefore, as with the fourth embodiment lamp assembly 310, the need for a separate lamp base, separable from the ballast, is also eliminated in this fifth embodiment lamp assembly 410. Furthermore, similar to the second and third embodiment lamp assemblies 110 and 210, the fifth embodiment lamp tube 424 is arranged in a coil having a radial extent greater than the outer radial extent of the ballast 430. The fifth embodiment lamp tube 424 provides for a very compact arrangement, with an overall height H5 (including height of an adapter 50, not shown) reduced from overall height H4 (for an equivalent length of lamp tubing). Additionally, the arrangement of the fifth embodiment lamp tube 424 provides enhanced illumination in the direction of the ballast 430 relative to the fourth embodiment lamp tube 324, as the greater radius of the lamp tube 424 mitigates shadowing effects of the fourth embodiment ballast 330. The third embodiment ballast 430 may (see FIG. 13) or may not (see FIG. 12) be provided with a screw thread 434 on an exterior surface of a ballast housing 432. The third embodiment ballast 430 is provided with input contacts 36, and is intended to mate in a bayonet-style connection with an adapter 50.

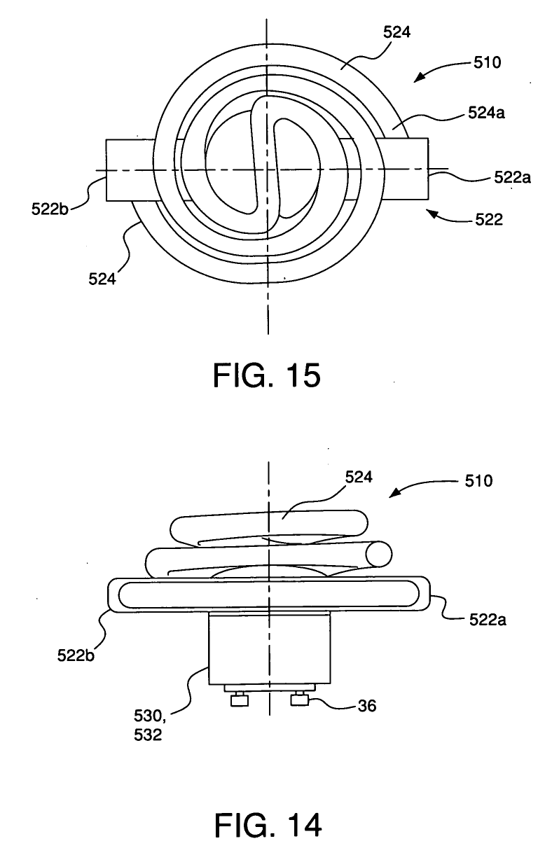

With reference now to FIGS. 14 and 15, a fluorescent lamp assembly 510 in accordance with a sixth preferred embodiment of the invention includes a lamp base 522 with opposing arms 522a and 522b. A lamp tube 524 having first and second ends 524a, 524b, respectively, connects to the opposing arms 522a, 522b. The lamp tube 524 is coiled in a “stacked” design, such that subsequent layers of the coil have different outer radial extents. That is, an uppermost first coil layer has a first outer radial extent, an adjacent lower second coil layer has a second outer radial extent greater than the first outer radial extent, and a lowermost third coil layer has a third outer radial extent greater than the second outer radial extent. This “stacked” arrangement promotes greater illumination from the lamp tube 524 of a given length relative to a conventional coil design having a uniform outer radial extent. The ballast 530 may or may not be provided with a thread on an exterior surface of the ballast housing 532.

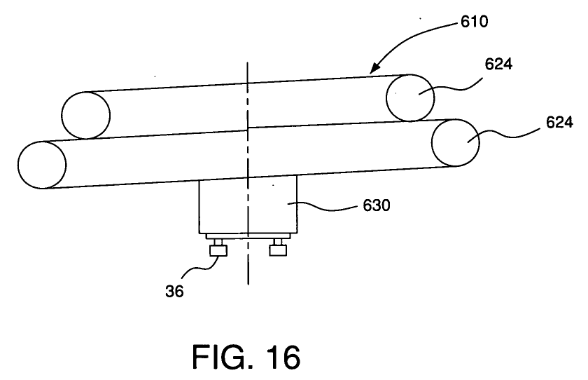

With reference now to FIG. 16, a fluorescent lamp assembly 610 in accordance with a seventh preferred embodiment of the invention includes a lamp base (not illustrated) with one or more arms (not shown) which extend radially to supply current to one or more generally circular fluorescent lamp tubes 624. The seventh preferred embodiment lamp assembly 610 includes a ballast 630, having a housing 632 with an exterior surface which may or may not be provided with threads.

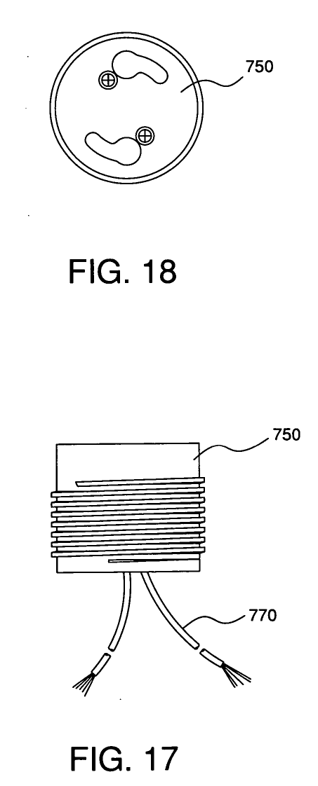

With reference now to FIGS. 17 and 18, an adapter 750 in accordance with an eighth preferred embodiment of the invention may be used in combination with a fluorescent lamp (not shown). The adapter 750 connects to the fluorescent lamp in a bayonet-style connection, as described above relative to adapter 50. While the adapter 50 is intended to be installed in a conventional incandescent light bulb socket, the adapter 750 in contrast is intended for permanent installation in a light fixture, having a pair of electrical lead wires 770 for connection to electrical contacts to provide power to the fluorescent lamp. The adapter 750 would thus be intended for use, for example, as original equipment in a lamp supplied by the manufacturer to the consumer for use with fluorescent lamps having a bayonet style connection.

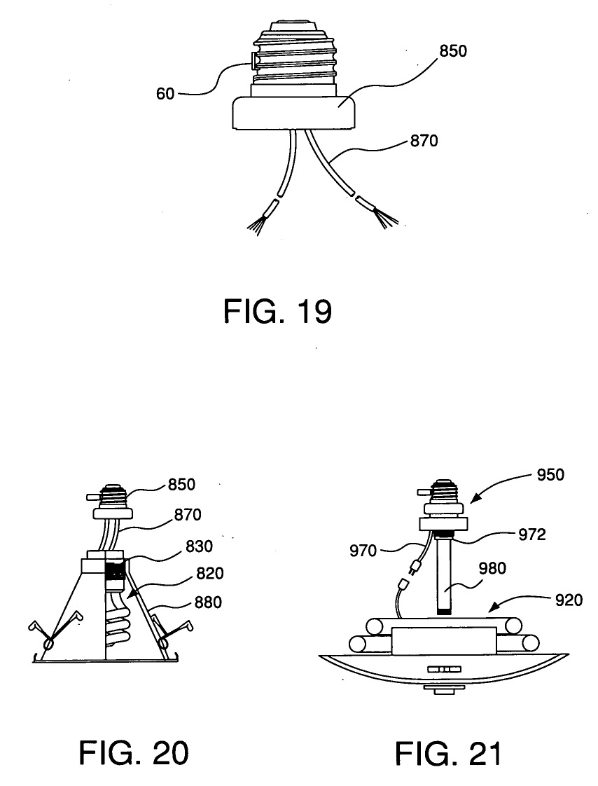

With reference now to FIGS. 19-20, an adapter 850 in accordance with a ninth preferred embodiment of the invention may be used in combination with a fluorescent lamp 820. The adapter 850 includes a locking tab 60, as described above. The adapter 850 installs in a conventional incandescent light bulb socket (not shown), and the locking tab 60 prevents removal of the adapter 850 following installation. However, rather than connecting to a ballast in a bayonet style connection as is used with the adapter 50, the adapter 850 connects to the ballast remotely in a conventional manner via wires 870 and electrical contacts. The adapter 850 is adapted for use in installations where the socket is remote from the lamp, and is particularly well-suited for recessed-lighting applications, where a recessed fixture 880 may be connected to a ballast portion 830 of the lamp 820.

With reference now to FIG. 21, an adapter 950 in accordance with a tenth preferred embodiment of the invention may be used in combination with a fluorescent lamp 920. The adapter 950 is similar to the adapter 850, having wires 970 for electrically connecting the adapter 950 to the lamp 920. However, the adapter 950 further includes a fitting 972. The fitting 972 is preferably threaded, and is adapted to connect to a stem 980. The stem 980 in turn is adapted to connect to the lamp 920.

The present invention may be embodied in other specific forms without departing from the spirit or essential attributes thereof. Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A fluorescent lamp assembly, comprising:
a fluorescent lamp having contact pins;
an adapter including:
a tip contact compatible with an electrical socket,
a threaded ring contact compatible with the electrical socket and capable of being installed in the electrical socket by rotation of the lamp assembly relative to the electrical socket in a first direction, and
keyhole slot receptacles;
a fluorescent ballast having input electrodes in electrical contact with the tip contact and the ring contact, respectively, and output electrodes for removably receiving the contact pins of the fluorescent lamp, wherein the keyhole slot receptacles are adapted to receive the ballast input electrodes in a bayonet style connection; and
a locking tab for preventing relative rotation between the ring contact and the electrical socket when the lamp assembly is rotated in a second direction opposite the first direction.

2. The fluorescent lamp assembly of claim 1 further comprising a lamp assembly having a longitudinal axis, the lamp further including a base member having a top and an outer periphery and a lamp tube having first and second ends and a longitudinal axis, wherein the first and second ends are connected to the base member such that the tube end longitudinal axis at each of the first and second ends lies in a plane substantially perpendicular to the lamp assembly longitudinal axis.

3. The fluorescent lamp assembly of claim 1, the lamp further including a base member having a top and a bottom and a recess extending into the base member from the bottom toward the top, wherein the contact pins connect to the lamp assembly within the recess.

4. A fluorescent lamp assembly comprising:
a fluorescent ballast, and
a fluorescent lamp having a lamp tube with first and second ends directly and fixedly connected to the ballast,
wherein the lamp tube has an outer radial extent greater than an outer radial extent of the ballast.

5. A fluorescent lamp assembly according to claim 4, for use with an electrical adapter having output electrodes, wherein the fluorescent ballast has input electrodes adapted to connect to the adapter electrodes in a bayonet style connection.

6. A fluorescent lamp comprising:
a coiled lamp tube; and
a base with a connector for detachably connecting the lamp to a ballast;
wherein the connector comprises a recess in the base for receiving a projecting connector on the ballast, and
a coil of the lamp tube encircles the recess and overlaps the recess in an axial direction of the coil.

7. A fluorescent lamp according to claim 6, wherein the coiled lamp tube has a plurality of turns and is connected to the base at an axial end overlapping the recess axially.

8. A fluorescent lamp according to claim 7, wherein the coiled lamp lies generally on a notional conical surface, and the recess is within the wider end of the coiled lamp.

9. A fluorescent lamp according to claim 6 in combination with a fluorescent ballast, wherein the ballast has a projecting connector arranged to be received in the recess of the base of the lamp.

10. A fluorescent lamp and ballast combination according to claim 9, wherein projecting connector is formed by a distal end of the ballast.
